(19) United States
(12) Patent Application Publication
(10) Pub. No.: US 2023/0380467 A1
(43) Pub. Date: Nov. 30, 2023

(54) Edible Food Product Preparations Having Accurate Dosages of Cannabinoids

(71) Applicant: Devin Weisleder, Richmond, VA (US)

(72) Inventor: Devin Weisleder, Richmond, VA (US)

(21) Appl. No.: 18/232,149

(22) Filed: Aug. 9, 2023

Related U.S. Application Data
(62) Division of application No. 17/494,284, filed on Oct. 5, 2021.
(60) Provisional application No. 63/087,561, filed on Oct. 5, 2020.

(51) Int. Cl. A23L 33/105; A23P 10/30

(52) U.S. Cl. CPC A23L 33/105; A23P 10/30; A23V 2002/00

(57) ABSTRACT

Systems, methods, and products involve preparations of edible food products having a cannabinoid, such as cannabidiol (“CBD”), or another variant, alone or in combination, in accurate, predetermined dosages of the cannabinoid, in which a cannabinoid dosing module is adapted to administer predetermined amounts of the cannabinoid to pre-final food products for incorporation of the cannabinoid into the pre-final food products to create final food products having the accurate, predetermined cannabinoid dosages, and in which a food product handling module is adapted to handle and/or hold the food products during cannabinoid incorporation, wherein cannabinoid incorporation may include desiccating a solvent of a solvent-based cannabinoid additive solution having the predetermined amount of cannabinoid, resulting in the final food product having the accurate, predetermined cannabinoid dosage.

### CROSS-REFERENCE TO RELATED APPLICATIONS

This application is a U.S. non-provisional patent application that claims the benefit of the U.S. provisional patent application entitled “Edible Food Product Preparations Having Accurate Dosages of Cannabinoids,” having Ser. No. 63/087,561, filed Oct. 5, 2020, which is hereby incorporated by reference in its entirety as if fully set forth herein.

### BACKGROUND OF THE INVENTION

Embodiments of the present invention generally relate to systems for, methods for, and products of preparations of edible food products having cannabinoids, such as cannabidiol (“CBD”). More specifically, the present invention relates to systems and methods, and products thereof, for preparations of edible snacks, such as dog treats, having accurate, predetermined dosages of a cannabinoid additive, having a determined content of at least one cannabinoid, such as CBD. An exemplary embodiment might include a dry, crispy, heart-shaped dog biscuit made of various healthy ingredients and containing an accurate CBD dosage per biscuit. Each biscuit may be small enough, relative to the size of dog to which the biscuit is to be given, that the biscuit will be consumed predictably in its entirety to reasonably ensure that the entire CBD dosage is received by the dog.

The related art includes, for instance, formulation of edible compositions having cannabis extracts, such as gummi bears, cookies, brownies, chocolates, condiments, ‘fortified’ butter, and assorted beverages. Edible forms of cannabis, including food products, lozenges, and capsules, can produce noticeable, long-lasting effects. Many edibles contain a significant amount of tetrahydrocannabinol (“THC”). THC-dominant edibles are consumed for recreational and medical purposes and can induce a wide range of effects including relaxation, euphoria, increased appetite, fatigue, and anxiety. Some edibles feature other cannabinoids predominantly, most commonly cannabidiol (“CBD”) with very little THC. Cannabidiol has been identified as having multiple favorable effects for some users, including possible homeopathic results. CBD products are frequently used for several issues associated with wellness, including sleep, relaxation, mood, skin care, and focus.

CBD may be extracted from hemp, also called industrial hemp, which includes plant varieties that typically contain very little THC and refer to the non-intoxicating varieties of cannabis. Hemp-derived CBD products typically contain less than 0.3% THC, so they do not produce the psychoactive “high” typically associated with marijuana. Marijuana includes the plant varieties that typically contain significant THC content, largely due to intentional breeding efforts over the years, and refers to the intoxicating varieties of cannabis. For some people, CBD cannabinoids act like an antidote for those who have consumed too much THC.

Due to the complex chemical structure of cannabis and its extracts, the chemical structure lends itself to multiple variations. There are about 120 cannabinoids found in cannabis, and several of these other cannabis-derived compounds are discussed in the prior art. The primarily relevant cannabinoids include tetrahydrocannabinol (THC), tetrahydrocannabinolic acid (THCA), cannabidiol (CBD), cannabidiolic acid (CBDA), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabielsoin (CBE), and cannabicitran (CBT). However, CBD and THC are the compounds that are the focus of most cannabinoid products.

### BRIEF SUMMARY OF THE INVENTION

Briefly stated, the invention comprises systems, methods, and products that involve preparations of edible food products having a cannabinoid, such as cannabidiol (“CBD”), or another variant, alone or in combination, in accurate, predetermined dosages of the cannabinoid, in which a cannabinoid dosing module is adapted to administer predetermined amounts of the cannabinoid to pre-final food products for incorporation of the cannabinoid into the pre-final food products to create final food products having the accurate, predetermined cannabinoid dosages, and in which a food product handling module is adapted to handle and/or hold the food products during cannabinoid incorporation, wherein cannabinoid incorporation may include desiccating a solvent of a solvent-based cannabinoid additive solution having the predetermined amount of cannabinoid, resulting in the final food product having the accurate, predetermined cannabinoid dosage

In one aspect of the present invention, a system is provided for preparation of edible food products having accurate, predetermined dosages of a cannabinoid, such as CBD. In an exemplary system using CBD as an exemplary cannabinoid, the exemplary system includes a food product handling module and a cannabinoid dosing module, wherein the cannabinoid dosing module is adapted to administer predetermined amounts of cannabinoid to pre-final food products for incorporation of the cannabinoid into the pre-final food products to create final food products having accurate cannabinoid dosages, and wherein the food product handling module is adapted to handle and/or hold food products during cannabinoid incorporation, with some embodiments including transporting the food products, desiccating a solvent used in cannabinoid incorporation into the pre-final food products, and packaging the final food products.

In another aspect of the present invention, a method is provided for preparation of edible food products having accurate, predetermined dosages of a cannabinoid, such as CBD. In an exemplary method using CBD as an exemplary cannabinoid, the exemplary method includes providing a food product handling module; providing a cannabinoid dosing module; using the cannabinoid dosing module to administer predetermined amounts of cannabinoid to pre-final food products, to incorporate the cannabinoid into the pre-final food products, and to create final food products having accurate cannabinoid dosages; and using the food product handling module to handle and/or hold food products during cannabinoid incorporation. In some embodiments, the method includes using the food product handling module to transport the food products, to desiccate a solvent used in cannabinoid incorporation into the pre-final food products, and to package the final food products.

In further aspect of the present invention, an edible food product is provided having an accurate, predetermined dosage of a cannabinoid, such as CBD. In an exemplary food product using CBD as an exemplary cannabinoid, the exemplary food product includes a predetermined amount of cannabinoid incorporated into a pre-final food product that results in a final food product having an accurate CBD dosage. This food product may be a product of a process of incorporating a predetermined amount of cannabinoid in a solvent-based solution into a pre-final food product, desiccating a solvent of the solution, and creating a final food product having an accurate cannabinoid dosage. In some embodiments, the food product may include a portion of the solvent in the final food product, wherein the portion of the solvent is a residue amount that is non-toxic and biocompatible for the solvent.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. The embodiments shown in the drawings are not necessary to scale, to shape, to form, or to size; they do not necessarily include all possible features in the depicted embodiments; and the positions and proportions of embodiments and features may vary. In the drawings:

FIG. 1 depicts a block diagram of a system for preparation of edible food products having accurate, predetermined dosages of a cannabinoid, such as CBD, in accordance with one embodiment of the present invention; and,

FIG. 2 depicts a block diagram of a flowchart of the steps of a process for preparation of edible food products having accurate, predetermined dosages of a cannabinoid, such as CBD, in accordance with one embodiment of the present invention.

### DETAILED DESCRIPTION OF THE INVENTION

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a tip” includes a plurality of tips. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs, and materials are now described. All publications mentioned herein are incorporated herein by reference in their entirety. Where there are discrepancies in terms and definitions used in references that are incorporated by reference, the terms used in this application shall have the definitions given herein.

### Definitions

As used herein, all variations of the term “cannabidiol” and its abbreviation “CBD” refer categorically to the numerous forms and formulations of non-psychoactive, non-intoxicating cannabis-based cannabinoid compounds, which exclude THC and related psychoactive, intoxicating compounds. As used herein, “cannabidiol” and “CBD” thus encompass non-intoxicating cannabinoids that do not fall strictly within the chemical definition of “cannabidiol” of C₂₁H₃₀O₂. As used herein, “cannabinoid” includes both the non-intoxicating and intoxicating forms of cannabis-related compounds, which may be segregated broadly into the categories of non-intoxicating cannabinoids and intoxicating cannabinoids.

### Exemplary Embodiments of the Invention

Exemplary embodiments of the invention include systems, methods, and products involving preparations of edible food products having cannabidiol in accurate, predetermined dosages of a cannabinoid, such as CBD, in which a cannabinoid dosing module is adapted to administer predetermined amounts of the cannabinoid, in the form of a cannabinoid additive, to pre-final food products for incorporation of the cannabinoid into the pre-final food products to create final food products having the accurate cannabinoid dosages, and in which a food product handling module is adapted to hold the food products during cannabinoid incorporation, wherein cannabinoid incorporation includes desiccating a solvent of a solvent-based solution having the predetermined amount of cannabinoid, which comprises the cannabinoid additive, resulting in the final food product having the accurate cannabinoid dosage. The amount of cannabinoid dosage depends largely on the context, purpose, and recipient, including sensitivity to cannabinoids, size, and weight of the recipient. However, in exemplary products having CBD as the cannabinoid, a common predetermined amount of CBD per dog biscuit in the aforementioned exemplary embodiment might be within a range of 20 mg-30 mg, such as 25 mg, per biscuit.

The cannabinoid additive may include, for instance, a measured amount of cannabinoid and a measured amount of solvent, possibly in combination with a measured amount of one or more stabilizers, a measured amount of one or more emulsifiers, a measured amount of one or more preservatives, and/or a measured amount of one or more bonding agents, each measured amount preferably determined accurately and precisely within acceptable margins of error for the amount and potency of the cannabinoid dosage. Accuracy is the measure of how close the measurement of a measured amount is to the actual amount, usually determined by a measurement device that is more sensitive (i.e., more accurate) than the dosing device that dispensed the measured amount. Precision is the measure of how close the measurements of repeated measured amounts are to each other and to the desired actual amount to be dispensed, also determined by a more sensitive measurement device testing multiple samples. Whereas most or all of the solvent would be removed during processing, the cannabinoid, stabilizers, emulsifiers, preservatives, and/or bonding agents presumably would remain unchanged once the solvent is removed by desiccation. The cannabinoid additive may include a coloring agent, such as a safety mechanism and presence identifier, to visibly identify the presence and location of the cannabinoid additive applied to the pre-final food product. The cannabinoid additive may include a flavoring agent and/or a perfuming agent, which also may identify the presence of the cannabinoid additive applied to the pre-final food product, and also may improve and/or mask the flavor or scent of the cannabinoid additive, if such identification, improvement, or masking is desirable.

In particular, an accurate cannabinoid dosage may be achieved by applying a predetermined amount of cannabinoid additive directly to an otherwise ready-prepared edible food product, such that the predetermined amount of cannabinoid remains constant and known per product and is not changed by subsequent processing of the food product. For instance, prior to incorporation of the cannabinoid, edible food products may be created and processed to a state in which they are almost ready for packaging, which may include mixing a combination of ingredients; sizing the combination into portions; forming the sized portions into unfinished food products; baking, cooking, refrigerating, setting, or desiccating the sized-portion unfinished food products; and finishing the unfinished food products to create pre-final food products ready to receive the cannabinoid, in the form of the cannabinoid additive.

Incorporation of the cannabinoid into the pre-final food products may include application of a cannabinoid additive, comprising a solvent-based cannabinoid solution, to the pre-final food products to create cannabinoid-containing pre-final food products, followed by desiccation of the solvent from the cannabinoid additive in the cannabinoid-containing pre-final food products, resulting in final food products having predetermined amounts of cannabinoid as accurate cannabinoid dosages. The solvent must be sufficiently volatile under the processing parameters suitable for the food products being prepared. The predetermined amount of cannabinoid per food product may be achieved by accurately mixing cannabinoid in the solvent to attain a known concentration of cannabinoid in solution, to create the cannabinoid additive to be added to the pre-final food products, and then accurately administering measured amounts of the cannabinoid additive solution to each of the food products, calculated with reference to a desired cannabinoid dosage per product.

Accurately administering measured amounts of the solution may be achieved using a cannabinoid dosing module that includes a reservoir of the cannabinoid additive of cannabinoid in solution connected to a dose measurement device, such as a pipette or weight scale, with a control mechanism, such as a computer-automated valve system, that isolates from the reservoir and into the dose measurement device a measured amount of cannabinoid additive solution having the predetermined amount of cannabinoid, and dispenses the measured amount of solution per individual food product. For instance, a pipette assembly may be filled with the measured amount of cannabinoid additive solution and then emptied of the measured amount of solution to administer the entirety of the measured amount of cannabinoid additive directly to the individual food product without any waste or misdirected solution not reaching or staying on the food product.

If appropriate, the food product may be sized and formed to include a pool-shaped depression large enough to hold the measured amount of cannabinoid additive solution per food product, to aid in retaining the cannabinoid additive solution and avoiding loss of cannabinoid additive solution during processing. The rate of absorption of the cannabinoid additive solution into the food product also may affect the processing parameters, and slower rates of absorption of the cannabinoid additive solution may require that the food product remain still and unmoved for a period of time needed for the cannabinoid additive solution to be absorbed, in part or in full, depending on the product and subsequent processing involved.

Evaporation of the solvent during the desiccation process leaves behind in the food product preferably only the measured amount of cannabinoid, and any minimal measured amounts of stabilizers, emulsifiers, preservatives, bond agents, coloring agents, flavoring agents, and/or perfuming agents, as may be present in the cannabinoid additive. Incomplete evaporation of the solvent may leave behind a solvent residue amount in the food product, such that any solvent residue amount must be non-toxic and biocompatible in the amount per product that reasonably might be left behind. Solvents that are non-toxic and biocompatible in small residue amounts are known in the art and may include, for instance, ethanol and water, depending on the intermediate form of cannabinoid being used. Common forms of cannabinoids, such as CBD, include an isolate form and a distillate form, and a given form may include other delivery compounds. For example, a CBD-containing oil may be dissolved using ethanol as the solvent, whereas a CBD-containing water-soluble crystalline compound (e.g., incorporated into a crystallized form of a sugar or a salt) may be dissolved using water as the solvent. Both ethanol and water are sufficiently volatile under typical food processing parameters to adequately evaporate during desiccation of the food products, and any solvent residue amounts would be non-toxic and biocompatible.

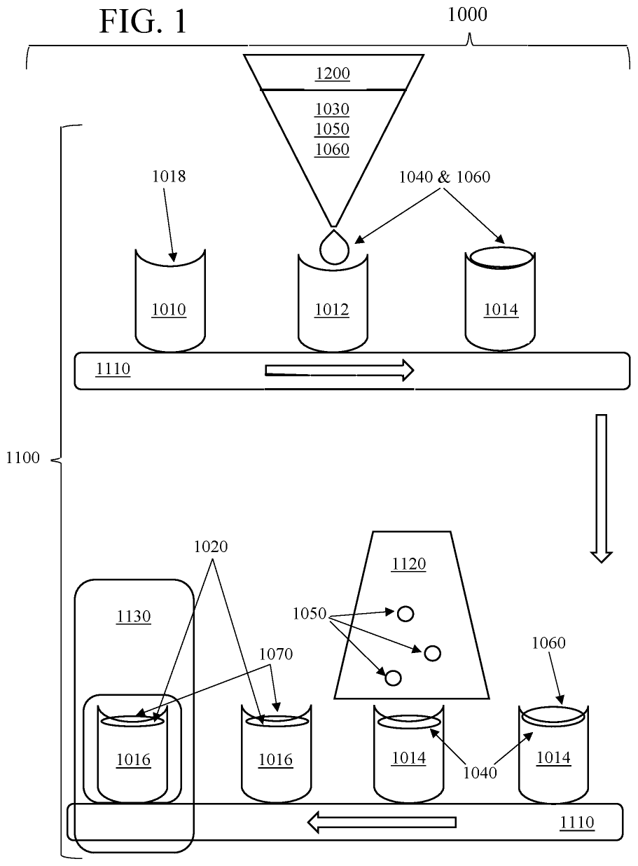

Referring to FIG. 1, FIG. 1 depicts a system 1000 for preparation of edible food products 1010 having accurate, predetermined dosages 1020 of a cannabinoid 1030, such as CBD. As depicted, this system 1000 includes a food product handling module 1100 and a cannabinoid dosing module 1200, wherein the cannabinoid dosing module 1200 is adapted to administer predetermined amounts 1040 of cannabinoid 1030, in the form measured amounts of cannabinoid additive 1060, to pre-final food products 1012 for incorporation of the cannabinoid 1030 into the pre-final food products 1012, yielding cannabinoid-containing pre-final food products 1014, to create final food products 1016 having accurate cannabinoid dosages 1020. The food product handling module 1100 is adapted to handle and/or hold food products 1010 during cannabinoid incorporation, with some embodiments including a transport module 1110 for transporting the food products 1010, a desiccation module 1120 for desiccating a solvent 1050 from a solvent-based cannabinoid additive solution, in the form of cannabinoid additive 1060, used in cannabinoid incorporation into the pre-final food products 1012, 1014, and a packaging module 1130 for packaging the final food products 1016. In some embodiments, the food product 1010, 1012 may include a pool-shaped depression 1018 large enough to hold the measured amount of cannabinoid additive solution 1060 per food product 1010, 1012, 1014. The food product handling module 1100 further may be adapted to form or create the pool-shaped depression 1018, such as using a food-shaping module or such, not shown. In general, the food product handling module 1100 may comprise one or more separate, combined, and/or integrated modules that perform separate, sequential, combined, or integrated steps in the overall processing of the food products. The block-diagram depictions of food product handling module 1100 are illustrative only and not limiting in nature, as any actual embodiment of the manufacturing process would be much more detailed than shown.

As shown in FIG. 1, an edible food product 1016 is provided having an accurate, predetermined dosage 1020 of cannabinoid 1030. This food product 1016 includes a measured amount 1040 of cannabinoid additive 1060 having a predetermined amount 1040 of cannabinoid 1030 incorporated into pre-final food product 1012 to create a cannabinoid-containing pre-final food product 1014, which, upon further processing, results in a final food product 1016 having an accurate cannabinoid dosage 1020.

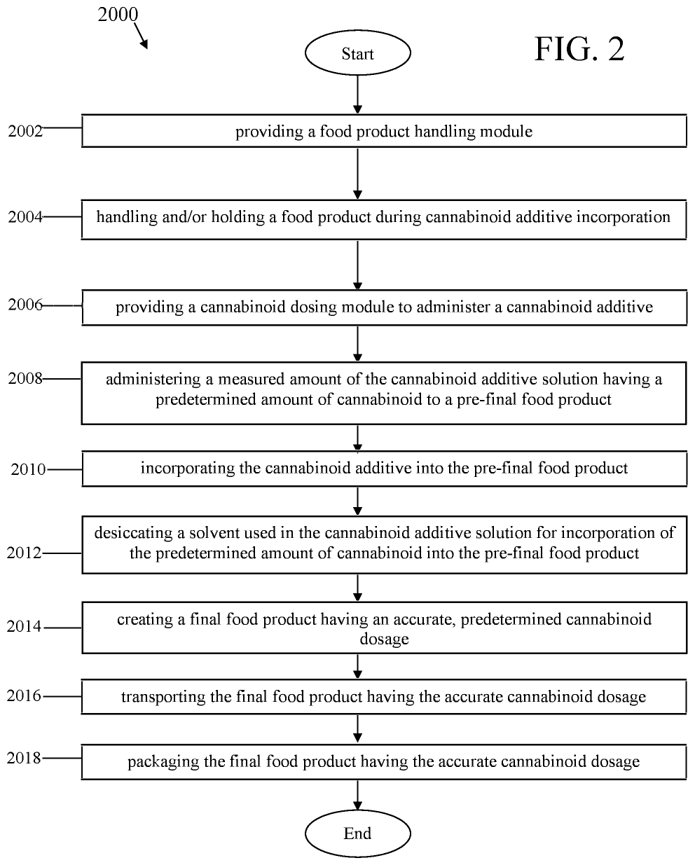

Referring to FIG. 2, FIG. 2 depicts a method 2000 for preparation of edible food products having accurate, predetermined dosages of a cannabinoid. This method 2000 includes providing 2002 a food product handling module, using the food product handling module in handling and/or holding 2004 food products during cannabinoid incorporation, providing 2006 a cannabinoid dosing module, using the cannabinoid dosing module in administering 2008 predetermined amounts of cannabinoid to pre-final food products, incorporating 2010 the cannabinoid into the pre-final food products, desiccating 2012 a solvent used in cannabinoid incorporation into the pre-final food products, and creating 2014 final food products having accurate cannabinoid dosages. In some embodiments, the method 2000 includes using the food product handling module in transporting 2016 the food products, which may include desiccating 2012 a solvent used in cannabinoid incorporation into the pre-final food products, and packaging 2018 the final food products. In some embodiments, the pre-final food product may be sufficiently absorbent or adsorbent to enable incorporating 2010 the cannabinoid into the pre-final food products without the necessity of separately desiccating 2012 the solvent of the cannabinoid additive, in which case, the solvent may disperse within the food product, and/or evaporate on its own. The steps of method 2000 may be performed by various combinations of hardware and software, such as software-controlled devices and mechanisms that automate the processes and processing of the food product manufacturing. Controls may be computerized, and quality measurements may be made at one or more points to ensure proper execution of the processes. Control data and quality measurement data may be communicated within the system and between the software, hardware, and automation devices, using wired and/or wireless connections, either locally or remotely.

As shown in FIG. 1 with reference to FIG. 2, an edible food product 1016 may be a product of a process 2000 of incorporating 2010 a predetermined amount 1040 of cannabinoid 1030 in a measured amount 1040 of solvent-based cannabinoid additive solution 1060 into a pre-final food product 1012 to create a cannabinoid-containing pre-final food product 1014, desiccating 2012 a solvent 1050 of the cannabinoid additive solution 1060 from the cannabinoid-containing pre-final food product 1014, and creating 2014 a final food product 1016 having an accurate cannabinoid dosage 1020. The process 2000 also may include, although not depicted, the step(s) of creating, using the food product handling module, a pool-shaped depression 1018 in each pre-final food product 1010, in which the pool-shaped depression 1018 is large enough to hold the measured amount 1040 of cannabinoid additive solution per food product 1012, 1014.

In some embodiments, the food products 1016 may include a portion 1070 of the solvent 1050 in the final food products 1016, wherein the portion 1070 of the solvent 1050 is a solvent residue amount 1070 that is non-toxic and biocompatible for the solvent 1050. The non-toxic and biocompatible nature of the residue amount 1070 is relative to the solvent 1050, the final food product 1016, and an intended consumer (not depicted) of the final food product 1016. For instance, a dog biscuit as the final food product 1016 for a very small or tiny dog (as the intended consumer of the dog biscuit) may have a smaller predetermined amount of cannabinoid 1040 in a smaller measured amount 1040 of cannabinoid additive solution 1060, and consequently a smaller residue amount 1070, than might be used, present, residual, and intended in a final food product 1016 for a very large dog.

Although several processes may have been disclosed herein as software, it may be appreciated by one of skill in the art that the same processes, functions, etc. may be performed via hardware or a combination of hardware and software. Similarly, although the present invention may have been depicted as a hardwired system, these concepts may be applied to wireless systems and hybrid hardwired and wireless systems without departing from the scope of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-11. (canceled)

12. A method for preparation of an edible food product having an accurate, predetermined dosage of a cannabinoid, the method comprising:
providing a food product handling module, wherein the food product handling module is adapted for handling of food products during incorporation of the cannabinoid;
providing a cannabinoid dosing module, wherein the cannabinoid dosing module is adapted for administering the accurate, predetermined dosage of the cannabinoid to each food product during cannabinoid incorporation;
handling, using the food product handling module, the food products during cannabinoid incorporation; administering, using the cannabinoid dosing module, a measured amount of a cannabinoid additive solution having a predetermined amount of cannabinoid to a pre-final food product; incorporating the predetermined amount of cannabinoid into the pre-final food product, and, creating a final food product having the accurate, predetermined dosage of the cannabinoid.

13. The method of claim 12, further comprising:
creating, using the food product handling module, a pool-shaped depression in each pre-final food product, in which the pool-shaped depression is large enough to hold the measured amount of cannabinoid additive solution per food product.

14. The method of claim 12, further comprising:
using the food product handling module for: transporting the food products;
desiccating a solvent of the cannabinoid additive solution during cannabinoid incorporation into the pre-final food product; and, packaging the final food products.

15-20. (canceled)
